(19) United States
(12) Patent Application Publication
(10) Pub. No.: US 2009/0025809 A1
(43) Pub. Date: Jan. 29, 2009

(54) ROTATABLE FAUCET WITH WATER TEMPERATURE RETAINING FEATURE

(76) Inventor: Tae Gon Oh, Los Angeles, CA (US)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/185,967

(22) Filed: Aug. 5, 2008

Related U.S. Application Data
(63) Continuation-in-part of application No. 11/560,303, filed on Nov. 15, 2006.

(51) Int. Cl. F16K 11/00

(52) U.S. Cl. 137/801

(57) ABSTRACT

A rotatable water faucet having a water temperature retaining feature includes a hot water control, a cold water control, a mixing chamber for receiving the hot and cold water, a water passage rotatably connected to the mixing chamber for dispensing a mixture of hot and cold water received from the mixing chamber through an outlet of the water passage, and a master control for controlling the dispensing of water through the outlet, wherein the master control is capable of stopping the dispensing of water through the outlet while at least one of the hot water control and the cold water control is in an open position, wherein rotation of the water passage is capable of stopping the dispensing of water through the outlet while the master control, and at least one of the hot water control and the cold water control are in the open position.

### CROSS-REFERENCES TO RELATED APPLICATIONS

This nonprovisional application is a continuation-in-part of currently pending U.S. application Ser. No. 11/560,303 filed Nov. 15, 2006, the entire contents of which are hereby incorporated by reference.

### FIELD OF THE INVENTION

The present invention relates to a water faucet, and more particularly, to an apparatus for retaining a temperature of water dispensed through the water faucet. The present invention also relates to a rotatable water faucet for controlling water flow by rotating a spout of the faucet.

### BACKGROUND OF THE INVENTION

Generally, a user utilizing a water faucet is able to manipulate water valves to attain a desired mix of hot and cold water or preferred water temperature according to the user's preference. However, maintaining the preferred water temperature can be difficult. For example, when washing hands at a sink, a user will turn on a water supply, manipulate the valves, and wait a certain amount of time to achieve the desired mix of hot and cold water. The user also needs to check the water temperature often or continuously to see whether the desired water temperature has been achieved. Since the preferred water temperature is lost when the user shuts off the conventional water faucet, the user needs to repeat this procedure each time the water faucet is used to reestablish the desired mix of hot and cold water if the user wishes to avoid washing with water having an undesired temperature.

Additionally, stagnant water within a hot water supply line is typically cold requiring the line to be flushed for a period of time before hot water is delivered. During such lag time, the hot water valve must carefully be manipulated to achieve a desired temperature. Because of this, the user may encounter unwanted water temperature fluctuations while using the water faucet, which may subject the user to undesirable water temperatures. Also, the user must wait an additional time for the cold stagnant water in the hot water supply line to heat up to a desired temperature. Accordingly, the user is further inconvenienced. Furthermore, a significant amount of water is wasted when the user is forced to readjust the water temperature or drain the hot water line of the cold stagnant water.

Moreover, when the conventional faucet is used at a sink, a spout of the faucet usually gets in a user's way when the user's hands or face are washed with water present in the sink because the sink is partially blocked by the spout hanging over the sink. It may be easier for the user to use the water in the sink if there were no faucet blocking over the sink, thus allowing the user to easily access the water in the sink from any direction. Therefore, there is currently a need for a device that retains a preferred water temperature by maintaining the user's desired mix of hot and cold water even after a water faucet is shut off. There is also a need for a retractable or rotatable faucet which is moved away or rotated from a sink such that the water in the sink is easily accessible without obstruction from the faucet.

### SUMMARY OF THE INVENTION

The present invention is directed to a rotatable water faucet and an apparatus for retaining a temperature of water dispensed through the rotatable water faucet.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a water faucet having a temperature retaining feature, the water faucet comprising a hot water control for controlling an amount of hot water flowing through the water faucet, wherein the hot water control allows hot water from a hot water supply to flow through the water faucet when the hot water control is in an open position, a cold water control for controlling an amount of cold water flowing through the water faucet, wherein the cold water control allows cold water from a cold water supply to flow through the water faucet when the cold water control is in an open position, a mixing chamber for receiving the hot water from the hot water supply and the cold water from the cold water supply, a first flow control cartridge operationally coupled with the hot water control for regulating the flow of hot water from the hot water supply into the mixing chamber, a second flow control cartridge operationally coupled with the cold water control for regulating the flow of cold water from the cold water supply into the mixing chamber, a water passage rotatably connected to the mixing chamber for dispensing a mixture of hot and cold water received from the mixing chamber through an outlet of the water passage, and a master control for controlling the dispensing of water through the outlet, wherein the master control is capable of stopping the dispensing of water through the outlet while at least one of the hot water control and the cold water control are in the open position, wherein rotation of the water passage is capable of stopping the dispensing of water through the outlet while the master control, and at least one of the hot water control and the cold water control are in the open position.

In one aspect of the present invention, the water passage includes a spout, spout chamber, and an inlet hole, and the water passage and the mixing chamber are rotatably connected at the inlet hole of the spout chamber and an outlet hole of the mixing chamber. The water passage may be rotatable in both clockwise and counterclockwise directions. The water passage may be rotatable about 90 degrees.

In another aspect of the present invention, rotation of the water passage during water flow controls an amount of the water flow such that the amount of the water flow gradually decreases as the water passage is turned away from a default position which is a position allowing a maximum amount of the water flow among a plurality of positions of the water passage.

Preferably, the water flow stops when the water passage is rotated to a predetermined point, closing an inlet hole of the water passage and an outlet hole of the mixing chamber. Preferably, the predetermined point is about 90 degrees away from the default position of the water passage. Alternatively, the predetermined point is where the outlet reaches near an inner edge of a sink into which the water from the outlet is filled when the water passage is rotated such that no water is dripped when the outlet points toward outer surface of the sink. Preferably, the water flow resumes when the water passage is rotated toward the default position from the predetermined point.

Preferably, the water faucet further includes a hot water pipe for connecting to the hot water supply, a hot water chamber connected between the hot water pipe and the mixing chamber, wherein the hot water chamber houses the first flow control cartridge, a cold water pipe for connecting to the cold water supply, and a cold water chamber connected between the cold water pipe and the mixing chamber, wherein the cold water chamber houses the second flow control cartridge.

In one aspect of the present invention, the first control cartridge includes an outer cartridge for retaining a fixed position of the first flow control cartridge within the hot water chamber and an inner cartridge rotatably fixed to the hot water control and rotatably coupled to an inner circumference of the outer cartridge, and the second control cartridge includes an outer cartridge for retaining a fixed position of the second flow control cartridge within the cold water chamber and an inner cartridge rotatably fixed to the cold water control and rotatably coupled to an inner circumference of the outer cartridge.

In another aspect of the present invention, the inner cartridge of the first flow control cartridge includes a stopper for regulating the flow of hot water from the hot water pipe into the hot water chamber, and the inner cartridge of the second flow control cartridge includes a stopper for regulating the flow of cold water from the cold water pipe into the cold water chamber.

In a further aspect of the present invention, the stopper of the first flow control cartridge includes an inlet hole for operating with a chamber hole of the hot water chamber to regulate hot water flow, and the stopper of the second flow control cartridge includes an inlet hole for operating with a chamber hole of the cold water chamber to regulate cold water flow.

In yet another aspect of the present invention, the amount of hot water flowing into the mixing chamber via the hot water chamber is dependent on a position of the inlet hole of the first flow control cartridge relative to the chamber hole of the hot water chamber, and the amount of cold water flowing into the mixing chamber via the cold water chamber is dependent on a position of the inlet hole of the second flow control cartridge relative to the chamber hole of the cold water chamber.

In yet a further aspect of the present invention, the position of the inlet hole of the first flow control cartridge relative to the chamber hole of the hot water chamber is controlled by the rotational movement of the inner cartridge via the hot water control, and the position of the inlet hole of the second flow control cartridge relative to the chamber hole of the cold water chamber is controlled by the rotational movement of the inner cartridge via the cold water control.

Preferably, the water faucet further includes a first check valve disposed on the stopper of the first flow control cartridge for movably sealing the inlet hole to prevent backflow of water into the hot water pipe, and a second check valve disposed on the stopper of the second flow control cartridge for movably sealing the inlet hole to prevent backflow of water into the cold water pipe.

An exterior of the water faucet may include markings for use with the hot and cold water controls to respectively measure the amount of hot and cold water capable of flowing through the water faucet.

Preferably, the master control is manipulated to seal the outlet when stopping the dispensing of water through the outlet while either of the hot water control and the cold water control is in the open position.

In accordance with another embodiment of the present invention, a water faucet having a water temperature retaining feature includes a hot water control for controlling an amount of hot water flowing through the water faucet, wherein the hot water control allows hot water from a hot water supply to flow through the water faucet when the hot water control is in an open position, a cold water control for controlling an amount of cold water flowing through the water faucet, wherein the cold water control allows cold water from a cold water supply to flow through the water faucet when the cold water control is in an open position, a mixing chamber for receiving the hot water from the hot water supply and the cold water from the cold water supply, a first flow control cartridge operationally coupled with the hot water control for regulating the flow of hot water from the hot water supply into the mixing chamber, a second flow control cartridge operationally coupled with the cold water control for regulating the flow of cold water from the cold water supply into the mixing chamber, a water passage rotatably connected to the mixing chamber for dispensing a mixture of hot and cold water received from the mixing chamber through an outlet of the water passage, and a master control for controlling the dispensing of water through the outlet. Preferably, the water passage is capable of controlling and stopping the dispensing of water through the outlet and the master control is also capable of stopping the dispensing of water through the outlet. Therefore, the dispensing of water through the outlet is controlled by at least one of the master control or the water passage while at least one of the hot water control and the cold water control is in the open position.

In an aspect of the present invention, rotation of the water passage from a substantially central position toward an edge of a sink decreases an amount of the water dispensed into the sink and the dispensing of water is stopped when the outlet of the water passage reaches near an inner peripheral edge of the sink such that no water drips out of the outlet when the outlet is positioned at an outer portion of the sink.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a rotatable faucet having a water temperature retaining feature in accordance wIth one embodiment of the present invention.

FIG. 2 illustrates an internal structure of a rotatable faucet having a water temperature retaining feature in accordance with one embodiment of the present invention.

FIG. 3 illustrates a flow control cartridge for use in a rotatable faucet in accordance with one embodiment of the present invention.

FIG. 4A illustrates a stopper of a flow control cartridge having a check valve in a closed position in accordance with one embodiment of the present invention.

FIG. 4B illustrates a stopper of a flow control cartridge having a check valve in an open position in accordance with one embodiment of the present invention.

FIG. 4C illustrates a top elevational view of a stopper of a flow control cartridge having a check valve in a closed position in accordance with one embodiment of the present invention.

FIG. 5A illustrates rotation of a water passage of a rotatable faucet over a sink in accordance with one embodiment of the present invention.

FIG. 5B illustrates a side view of a rotatable faucet having a water passage in a default position hanging over a sink in accordance with one embodiment of the present invention.

FIG. 5C illustrates a rotatable water passage of a rotatable faucet rotated away from a sink to stop the water flow from the faucet in accordance with one embodiment of the present invention.

FIG. 5D illustrates a side view of a rotatable faucet in a rotated position away from a sink in accordance with one embodiment of the present invention.

### DETAILED DESCRIPTION OF THE PREFERRED EMBODIMENTS

The present invention relates to a rotatable water faucet and an apparatus for retaining a temperature of water dispensed through the water faucet.

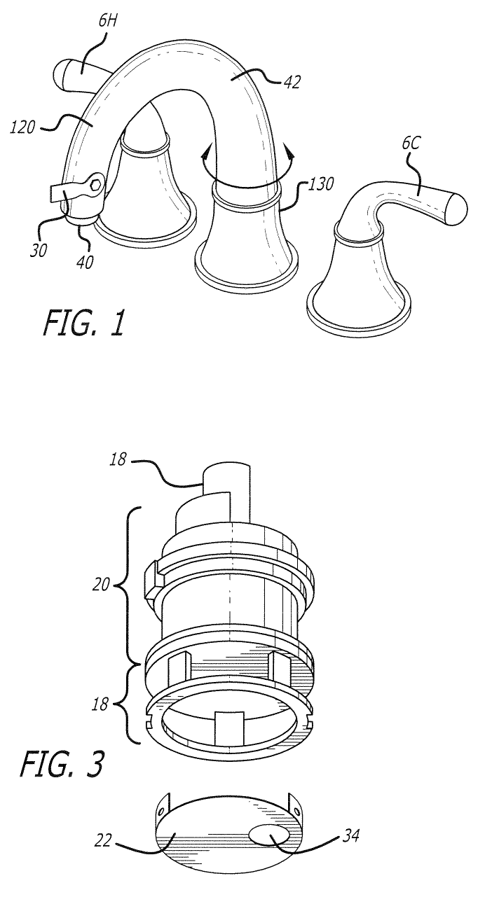

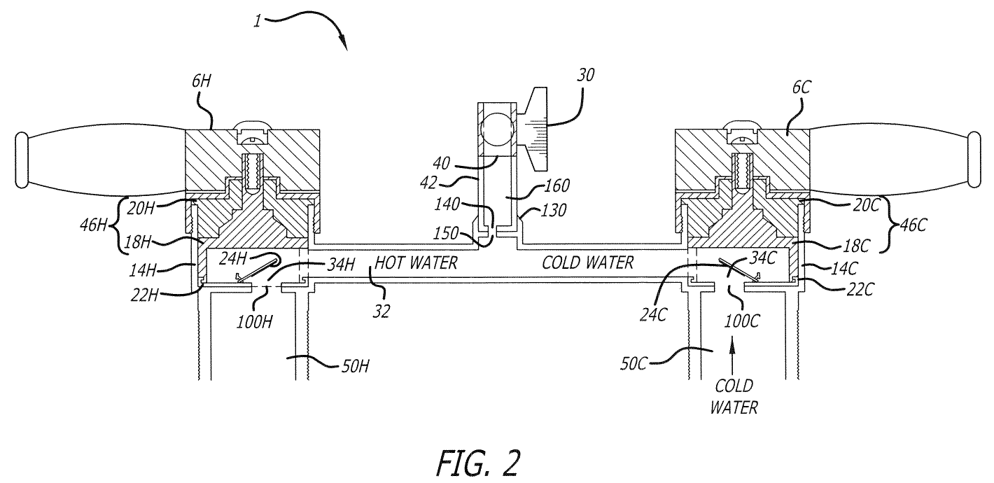

FIG. 1 illustrates a rotatable sink faucet having a water temperature retaining feature in accordance with one embodiment of the present invention. FIG. 2 illustrates an internal structure of the rotatable sink faucet having the water temperature retaining feature in accordance with one embodiment of the present invention.

Referring to FIGS. 1 and 2, the rotatable sink faucet 1 includes a hot water handle 6H for controlling the flow of hot water and a cold water handle 6C for controlling the flow of cold water through the sink faucet 1. When the hot water handle 6H is in a closed position, hot water from a hot water reservoir resides in a hot water pipe 50H. Likewise, when the cold water handle is in a closed position, cold water from a cold water reservoir resides in a cold water pipe 50C. When the hot water handle 6H is manipulated into an open position, the hot water residing in the hot water pipe 50H is allowed to flow into a mixing chamber 32. In the mixing chamber 32, the hot water mixes with the cold water flowing from the cold water pipe 50C when the cold water handle 6C is manipulated into an open position. Preferably, the hot and cold water handles are manipulated by a user such that a preferred mixed water temperature is achieved according to the user's preference. Furthermore, an exterior of the water faucet may comprise markings for use with the hot and cold water handles in order for the user to respectively measure the amount of hot and cold water capable of flowing through the water faucet.

After mixing in the mixing chamber 32, the mixed water flows through a water passage 42 to be dispensed through an outlet 40. In accordance with the present invention, the sink faucet 1 further includes a master handle 30 for controlling the dispensing of mixed water through the outlet 40. Preferably, the master handle 30 is disposed near the outlet 40 and is capable of sealing the outlet 40 to cease the dispensing of water. Accordingly, while the hot water handle 6H and the cold water handle 6C remain in the open position, mixed water flow through the outlet 40 may be stopped by manipulating the master handle 30 into a closed position. Thus, when the user achieves the preferred water temperature by successfully manipulating the hot water handle 6H and the cold water handle 6C to achieve a preferred ratio of hot and cold water, the user may use the master handle 30 to shut off water flow without having to close off the hot and cold water handles. This greatly conveniences the user the next time he/she wishes to use the sink faucet 1 because the user does not have to re-manipulate the hot and cold water handles 6H, 6C to attain the preferred ratio of hot and cold water.

Therefore, by leaving the hot and cold water handles 6H, 6C in the position they were prior to shutting off the master handle 30, the preferred mix of hot and cold water will be duplicated when the master handle 30 is moved to the open position at a later point in time. In addition, the volume of water flow can be adjusted up or down at any time by manipulating the master handle 30 without affecting the preferred ratio of hot and cold water, which was preset by the hot water handle 6H and the cold water handle 6C.

In addition to the master handle 30, the water flow can also be controlled by rotating a water passage 42. For example, while the hot water handle 6H and the cold water handle 6C are in the open position and the master handle 30 is also in the open position, the volume of water flow can be controlled or the water flow can be stopped completely by rotation of the water passage 42.

Referring to FIG. 2, a cold water chamber 14C houses a flow control cartridge 46C for regulating the flow of water from the cold water pipe 50C to the mixing chamber 32. As shown, the flow control cartridge 46C comprises an outer cartridge 20C and an inner cartridge 18C. The outer cartridge 20C helps retain a fixed lateral and longitudinal position of the flow control cartridge 46C within the cold water chamber 14C. Meanwhile, the inner cartridge 18C is rotatably coupled to an inner circumference of the outer cartridge 20C such that it can axially rotate relative to the outer cartridge 20C.

An upper portion of the inner cartridge 18C is attached to the cold water handle 6C. Preferably, the upper portion of the inner cartridge 18C is threaded, such that the cold water handle may be screwed down to the inner cartridge 18C. A lower portion of the inner cartridge 18C comprises a stopper 22C for regulating water flow. Preferably, the stopper 22C comprises an inlet hole 34C for operating with a chamber hole 100C of the cold water chamber 14C to regulate the flow of cold water from the cold water pipe 50C into the cold water chamber 14C, and eventually into the mixing chamber 32.

In operation, when the cold water handle 6C is turned to the closed position, the inner cartridge 18C, attached to the cold water handle 6C is also turned to the closed position. Accordingly, when the inner cartridge 18C is turned to the closed position, the inlet hole 34C of the stopper 22C is turned away from the chamber hole 100C to prevent cold water from entering into the cold water chamber 14C. However, when the cold water handle 6C is turned to an open position, the inner cartridge 18C consequently turns axially relative to the outer cartridge 20C. Accordingly, the inlet hole 34C of the stopper 22C turns toward the chamber hole 100C to allow cold water to flow through the cold water chamber 14C and into the mixing chamber 32. Preferably, present invention is designed such that the more the cold water handle 6C is turned to the open position, the more the inlet hole 34C is exposed to the chamber hole 100C to allow more cold water to flow into the mixing chamber 32.

Still referring to FIG. 2, a hot water chamber 14H houses a flow control cartridge 46H for regulating the flow of water from the hot water pipe 50H to the mixing chamber 32. As shown in FIG. 2, the flow control cartridge 46H includes an outer cartridge 20H and an inner cartridge 18H. The outer cartridge 20H helps retain a fixed lateral and longitudinal position of the flow control cartridge 46H within the hot water chamber 14H. Meanwhile, the inner cartridge 18H is rotatably coupled to an inner circumference of the outer cartridge 20H such that it can axially rotate relative to the outer cartridge 20H.

An upper portion of the inner cartridge 18H is attached to the hot water handle 6H. Preferably, the upper portion of the inner cartridge 18H is threaded, such that the hot water handle may be screwed down to the inner cartridge 18H. A lower portion of the inner cartridge 18H includes a stopper 22H for regulating water flow. Preferably, the stopper 22H includes an inlet hole 34H for operating with a chamber hole 1 00H of the hot water chamber 14H to regulate the flow of hot water from the hot water pipe 50H into the hot water chamber 14H, and eventually into the mixing chamber 32.

In operation, when the hot water handle 6H is turned to the closed position, the inner cartridge 18H, attached to the hot water handle 6H is also turned to the closed position. Accordingly, when the inner cartridge 18H is turned to the closed position, the inlet hole 34H of the stopper 22H is turned away from the chamber hole 100H to prevent hot water from entering into the hot water chamber 14H. However, when the hot water handle 6H is turned to an open position, the inner cartridge 18H consequently turns axially relative to the outer cartridge 20H. Accordingly, the inlet hole 34H of the stopper 22H turns toward the chamber hole 1OOH to allow hot water to flow through the hot water chamber 14H and into the mixing chamber 32. Preferably, present invention is designed such that the more the hot water handle 6H is turned to the open position, the more the inlet hole 34H is exposed to the chamber hole 100H to allow more hot water to flow into the mixing chamber 32.

Preferably, the hot and cold water combine in the mixing chamber 32 prior to flowing through the water passage 42 and being dispensed out of the outlet 40. According to a user's preference, the cold water handle 6C and the hot water handle 6H may be manipulated until a preferred ratio of hot and cold water is attained. Once the preferred ratio is achieved, the hot and cold water handles are left in their respective positions. When the user wishes to shut off water flow, the user may manipulate the master handle 30 to cease dispensing of the water. Accordingly, by using the master handle 30 to shut off water flow, the hot water handle 6H and the cold water handle 6C remain in the same respective positions they were in prior to shut off. Thus, when the user wishes to resume water flow at the preferred ratio of hot and cold water, the user may simply turn the master handle 30 to the open position without having to re-manipulate the hot and cold water handles. Also, by manipulating the master handle 30, the volume of water flow can be re-adjusted up or down without affecting the preferred ratio of hot and cold water.

Consequently, by being able to resume water flow without having to re-manipulate the hot and cold water handles, water may be conserved. For example, a maximum volume of water flow can be preset at the same time as the preferred water temperature using the hot and cold water handles 6H, 6C. Accordingly, when the master handle 30 is manipulated to resume water flow, only the maximum preset volume of water will flow through the outlet 40. This is advantageous with certain users, such as children, who may irresponsibly manipulate hot and cold water handles of a typical faucet without regard to water conservation. Hence, by utilizing the sink faucet of the present invention, users are able to easily conserve water without undue burden.

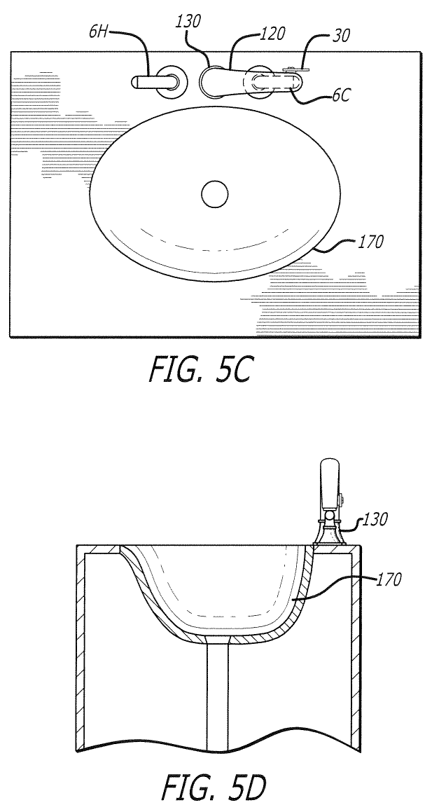

Alternatively, the water flow may also be controlled by rotation of the water passage 42. The water passage 42 includes a spout 120, a spout chamber 160, the outlet 40, and inlet hole 140. The water passage 42 is connected to the mixing chamber 32 via the inlet hole 140 of the water passage and an outlet hole 150 of the mixing chamber. When the outlet 40 of the water passage 42 is pointing toward a substantially central portion of a sink 170 (shown in FIG. 5A), the inlet hole 140 and the outlet hole 150 are positioned to allow a maximum amount of water flow. As the water passage 42 is rotated farther from the substantially central position toward an peripheral edge of the sink 170, the open space between the inlet hole 140 and the outlet hole 150 becomes smaller, thus decreasing the amount of the water flow. Therefore, when the water passage 42 reaches the peripheral edge of the sink 170 by rotation, the water flow is eventually ceased, thus preventing dripping of water from the sink faucet 1 when the outlet 40 is pointing toward the outer surface of the sink even when the master handle 30 is in the open position.

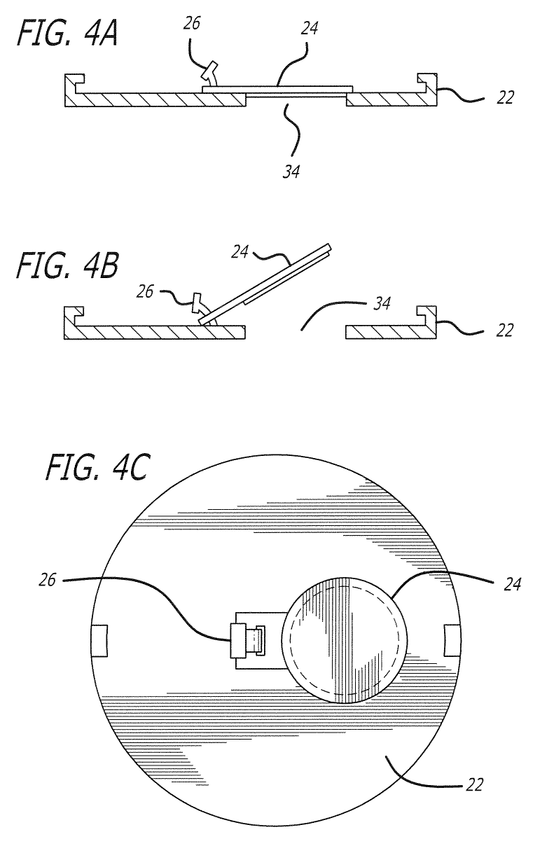

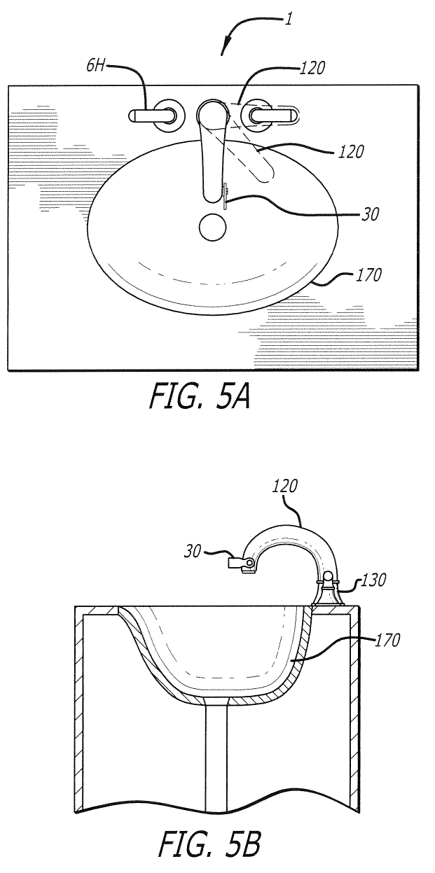

FIG. 3 illustrates a flow control cartridge for use in a sink faucet in accordance with one embodiment of the present invention. FIGS. 4A-4C illustrate a stopper of a flow control cartridge having a check valve in accordance with one embodiment of the present invention. Referring to FIGS. 2, 3 and 4A-4C, a check valve 24C is disposed on the stopper 22C for movably sealing the inlet hole 34C. Furthermore, a check valve 24H is disposed on the stopper 22H for movably sealing the inlet hole 34H. Preferably, a portion of the check valve 24C is coupled to the stopper 22C via a check valve hook 26C, and a portion of the check valve 24H is coupled to the stopper 22H via a check valve hook 26H. Here, the check valve hooks allow the respective check valves to open and close upon the respective inlet holes 34C and 34H.

In operation, when the cold water handle 6C is turned to the open position, pressure from the cold water flowing from the cold water pipe 50C toward the cold water chamber 14C causes the check valve 24C to lift up at one side, thus allowing the cold water to flow through the cold water chamber 14C and into the mixing chamber 32. Likewise, when the hot water handle 6H is turned to the open position, pressure from the hot water flowing from the hot water pipe 50H toward the hot water chamber 14H causes the check valve 24H to lift up at one side, thus allowing the hot water to flow through the hot water chamber 14H and into the mixing chamber 32.

However, when the user wishes to shut off water flow using the master handle 30 while the hot and cold water handles remain in the open position, a pressure difference between the hot and cold water in the mixing chamber 32 may cause backflow to occur. For example, if the pressure of hot water in the mixing chamber 32 is greater than the pressure of the cold water, then the water in the mixing chamber 32 will move toward the cold water chamber 14C and back into the cold water pipe 50C. Consequently, if hot water is allowed to enter into the cold water pipe 50C, the water within the cold water pipe 50C will be heated and can no longer be relied upon by the user to be consistently cold. Accordingly, the ability to maintain a preferred water temperature is lost due to the inconsistent temperature of the cold water.

Alternatively, if the pressure of cold water in the mixing chamber 32 is greater than the pressure of the hot water, then the water in the mixing chamber 32 will move toward the hot water chamber 14H and back into the hot water pipe 50H. Consequently, if cold water is allowed to enter into the hot water pipe 50H, the water within the hot water pipe 50H will be cooled and can no longer be relied upon by the user to be consistently hot. Accordingly, the ability to maintain the preferred water temperature is lost due to the inconsistent temperature of the hot water.

The present invention solves these problems by providing the check valves 24C and 24H. For example, when water in the mixing chamber 32 moves toward the cold water chamber 14C, the pressure of the water will cause the check valve 24C to sit down and seal the inlet hole 34C. Likewise, when water in the mixing chamber 32 moves toward the hot water chamber 14H, the pressure of the water will cause the check valve 24H to sit down and seal the inlet hole 34H. Accordingly, backflow into either the cold water pipe 50C or the hot water pipe 50H is prevented.

FIGS. 5A-5D illustrate rotation of the water passage 42 of the rotatable faucet 1 over a sink 170 in accordance with one embodiment of the present invention. Referring to FIG. 5A, the water passage 42 having the spout 120 and the outlet 40 is substantially centered relative to the sink 170, the outlet pointing toward a substantially central portion of the sink. When at least one of the hot water handle 6H and the cold water handle 6C is in the open position and the master control 30 is in the open position, water is dispensed through the outlet 40 of the water passage 42 that is substantially centered relative to the sink 170. The water flow may be shut off by moving the master control 30 to the closed position when a user finishes using the rotatable faucet 1.

However, if water was filled in a reservoir of the sink 170 and the user wishes to use the water in the sink, the water passage 42 blocks some space above the sink, as shown in FIGS. 5A and 5B. Therefore, the user is inconvenienced by the water passage 42 blocking the sink 170 when using the water in the sink. To avoid this inconvenience, the water passage 42 may be rotated toward a peripheral edge of the reservoir, as shown in FIGS. 5C and 5D.

In one aspect of the invention, while the master control 30 is still in the open position, the water flow may be shut off when rotating the rotatable water passage 42. This avoids the inconvenience of having to shut off the master control 30 first and then rotate the water passage 42 before using the water in the sink 170. When the water passage 42 is rotated away from the substantially centered position, the amount of water flow gradually decreases as the water passage is rotated farther away, as shown in FIG. 5A. When the water passage 42 reaches near the inner edge of the sink 170 by rotation, the water flow eventually ceases. Therefore, when the water passage 42 is rotated such that the outlet 40 is along the peripheral edge of the reservoir of the sink 170, no water will come out of the outlet, as shown in FIGS. 5C and 5D. Accordingly, because the water flow can be ceased simply by rotating the water passage 42 without having to turn off the master control 30, it is easier for the user to stop the water flow and use the water in the sink 170 more conveniently.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A rotatable water faucet having a water temperature retaining feature, the water faucet comprising:
a hot water control for controlling an amount of hot water flowing through the water faucet, wherein the hot water control allows hot water from a hot water supply to flow through the water faucet when the hot water control is in an open position;
a cold water control for controlling an amount of cold water flowing through the water faucet, wherein the cold water control allows cold water from a cold water supply to flow through the water faucet when the cold water control is in an open position;
a mixing chamber for receiving the hot water from the hot water supply and the cold water from the cold water supply;
a first flow control cartridge operationally coupled with the hot water control for regulating the flow of hot water from the hot water supply into the mixing chamber;
a second flow control cartridge operationally coupled with the cold water control for regulating the flow of cold water from the cold water supply into the mixing chamber;
a water passage rotatably connected to the mixing chamber for dispensing a mixture of hot and cold water received from the mixing chamber through an outlet of the water passage; and
a master control for controlling the dispensing of water through the outlet, wherein the master control is capable of stopping the dispensing of water through the outlet while at least one of the hot water control and the cold water control is in the open position,
wherein rotation of the water passage is capable of stopping the dispensing of water through the outlet while the master control, and at least one of the hot water control and the cold water control are in the open position.

2. The water faucet of claim 1, wherein the water passage comprises a spout, spout chamber, and an inlet hole, and the water passage and the mixing chamber are rotatably connected at the inlet hole of the spout chamber and an outlet hole of the mixing chamber.

3. The water faucet of claim 1, wherein the water passage is rotatable in both clockwise and counterclockwise directions.

4. The water faucet of claim 1, wherein the water passage is rotatable about 90 degrees.

5. The water faucet of claim 1, wherein rotation of the water passage during water flow controls an amount of the water flow such that the amount of the water flow gradually decreases as the water passage is turned away from a default position which is a position allowing a maximum amount of the water flow among a plurality of positions of the water passage, wherein the outlet of the water passage is directed toward a substantially central portion of a reservoir of a sink when the water passage is in the default position.

6. The water faucet of claim 5, wherein the water flow stops when the water passage is rotated to a predetermined position, and an inlet hole of the water passage and an outlet hole of the mixing chamber are closed.

7. The water faucet of claim 6, wherein the predetermined position is about 90 degrees away from the default position of the water passage.

8. The water faucet of claim 6, wherein the predetermined position is where the outlet reaches near an inner edge of the sink when the water passage is rotated such that no water is dripped when the outlet points toward an outer surface of the sink.

9. The water faucet of claim 6, wherein the water flow resumes when the water passage is rotated back toward the default position from the predetermined position.

10. The water faucet of claim 1, further comprising:
a hot water pipe for connecting to the hot water supply;
a hot water chamber connected between the hot water pipe and the mixing chamber, wherein the hot water chamber houses the first flow control cartridge;
a cold water pipe for connecting to the cold water supply; and
a cold water chamber connected between the cold water pipe and the mixing chamber, wherein the cold water chamber houses the second flow control cartridge.

11. The water faucet of claim 10, wherein:
the first control cartridge comprises an outer cartridge for retaining a fixed position of the first flow control cartridge within the hot water chamber and an inner cartridge rotatably fixed to the hot water control and rotatably coupled to an inner circumference of the outer cartridge; and
the second control cartridge comprises an outer cartridge for retaining a fixed position of the second flow control cartridge within the cold water chamber and an inner cartridge rotatably fixed to the cold water control and rotatably coupled to an inner circumference of the outer cartridge.

12. The water faucet of claim 11, wherein:
the inner cartridge of the first flow control cartridge comprises a stopper for regulating the flow of hot water from the hot water pipe into the hot water chamber; and
the inner cartridge of the second flow control cartridge comprises a stopper for regulating the flow of cold water from the cold water pipe into the cold water chamber.

13. The water faucet of claim 12, wherein:
the stopper of the first flow control cartridge comprises an inlet hole for operating with a chamber hole of the hot water chamber to regulate hot water flow; and
the stopper of the second flow control cartridge comprises an inlet hole for operating with a chamber hole of the cold water chamber to regulate cold water flow.

14. The water faucet of claim 13, wherein:
the amount of hot water flowing into the mixing chamber via the hot water chamber is dependent on a position of the inlet hole of the first flow control cartridge relative to the chamber hole of the hot water chamber; and
the amount of cold water flowing into the mixing chamber via the cold water chamber is dependent on a position of the inlet hole of the second flow control cartridge relative to the chamber hole of the cold water chamber.

15. The water faucet of claim 14, wherein:
the position of the inlet hole of the first flow control cartridge relative to the chamber hole of the hot water chamber is controlled by the rotational movement of the inner cartridge via the hot water control; and
the position of the inlet hole of the second flow control cartridge relative to the chamber hole of the cold water chamber is controlled by the rotational movement of the inner cartridge via the cold water control.

16. The water faucet of claim 13, further comprising:
a first check valve disposed on the stopper of the first flow control cartridge for movably sealing the inlet hole to prevent backflow of water into the hot water pipe; and
a second check valve disposed on the stopper of the second flow control cartridge for movably sealing the inlet hole to prevent backflow of water into the cold water pipe.

17. The water faucet of claim 1, wherein the master control is disposed on the spout.

18. The water faucet of claim 1, wherein the master control is manipulated to seal the outlet when stopping the dispensing of water through the outlet while either of the hot water control and the cold water control is in the open position.

19. A water faucet having a water temperature retaining feature, the water faucet comprising:
a hot water control for controlling an amount of hot water flowing through the water faucet, wherein the hot water control allows hot water from a hot water supply to flow through the water faucet when the hot water control is in an open position;
a cold water control for controlling an amount of cold water flowing through the water faucet, wherein the cold water control allows cold water from a cold water supply to flow through the water faucet when the cold water control is in an open position;
a mixing chamber for receiving the hot water from the hot water supply and the cold water from the cold water supply;
a first flow control cartridge operationally coupled with the hot water control for regulating the flow of hot water from the hot water supply into the mixing chamber;
a second flow control cartridge operationally coupled with the cold water control for regulating the flow of cold water from the cold water supply into the mixing chamber;
a water passage rotatably connected to the mixing chamber for dispensing a mixture of hot and cold water received from the mixing chamber through an outlet of the water passage, wherein the water passage is capable of controlling and stopping the dispensing of water through the outlet; and
a master control for controlling the dispensing of water through the outlet, wherein the master control is capable of stopping the dispensing of water through the outlet,
wherein the dispensing of water through the outlet is controlled by at least one of the master control or the water passage while at least one of the hot water control and the cold water control is in the open position.

20. The water faucet of claim 19, wherein rotation of the water passage from a substantially central position toward an edge of a sink decreases an amount of the water dispensed into the sink and the dispensing of water is stopped when the outlet of the water passage reaches near an inner peripheral edge of the sink such that no water drips out of the outlet when the outlet is positioned at an outer portion of the sink.
